(19) United States
(12) Patent Application Publication
(10) Pub. No.: US 2013/0241817 A1
(43) Pub. Date: Sep. 19, 2013

(54) DISPLAY DEVICE AND METHOD FOR ADJUSTING CONTENT THEREOF

(71) Applicants: CHI-CHIH WANG, Tu-Cheng (TW); TZU-TE WANG, Tu-Cheng (TW); KAI-CHIANG YANG, Tu-Cheng (TW)

(72) Inventors: CHI-CHIH WANG, Tu-Cheng (TW); TZU-TE WANG, Tu-Cheng (TW); KAI-CHIANG YANG, Tu-Cheng (TW)

(73) Assignee: HON HAI PRECISION INDUSTRY CO., LTD., Tu-Cheng (TW)

(21) Appl. No.: 13/590,063

(22) Filed: Aug. 20, 2012

(30) Foreign Application Priority Data
Mar. 16, 2012 (CN) 201210069625.4

(51) Int. Cl. G09G 5/00

(52) U.S. Cl. 345/156

(57) ABSTRACT

A displayer includes a display unit, a camera and a control unit. The display unit is configured to display video information. The camera is configured to obtain image information in front of the display unit. The control unit receives the image information of the camera, and adjusts the content of the display unit according to the image information of the camera.

### BACKGROUND

1. Technical Field

The disclosure generally relates to a display device, and a method for adjusting content of the display device.

2. Description of Related Art

Nowadays, display devices are widely used in marketplaces or squares. The display devices are usually for displaying movies, television programs or advertisements. However, in the display devices described above, the content of the display device is predetermined. The content of the display devices can not be adjusted according to different environments such as raining, snowing, or different audiences.

What is needed, therefore, is a display device which can overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an illustrating view of a display device in accordance with one embodiment of the disclosure.

FIG. 2 is a flow chart of a method for adjusting content of the display device of FIG. 1.

### DETAILED DESCRIPTION

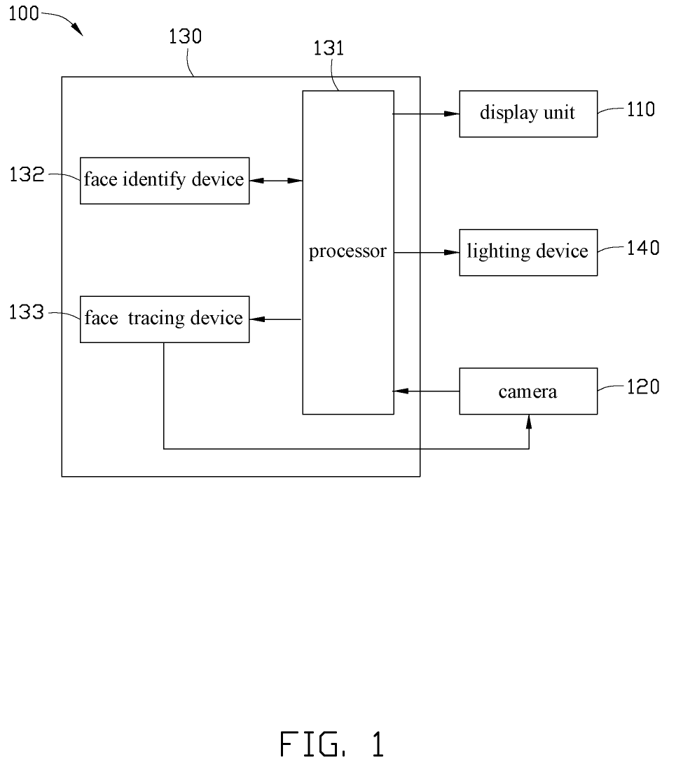

Referring to FIG. 1, a display device 100 in accordance with one embodiment of the disclosure is shown. The display device 100 includes a display unit 110, a camera 120 and a control unit 130.

The display unit 110 is configured for displaying many kinds of video information such as advertisement about cars or dresses. In addition, the display unit 110 can also play movies and music to attract audiences. In this embodiment, the display unit 110 can be selected from a group consisting of liquid crystal display, LED display, plasma display and projecting device. The display unit 110 can be placed at marketplaces, squares, stores, or buildings.

The camera 120 is configured for obtaining image information in front of the display unit 110, to determine information of ambient environment, such as number of audiences, weather conditions etc.

The control unit 130 receives the image information obtained by the camera 120, and adjusts the video information of the display unit 110 according to the information obtained by the camera 120. The information obtained by the camera 120 includes weather conditions such as whether is raining, whether is snowing, whether is too cold or too hot. In addition, the information obtained by the camera 120 can also include information of audiences, such as gender, age and ethnicity. In this embodiment, the control unit 130 includes a processor 131 and a face identify device 132 connected with the processor 131. The processor 131 transmits the image information obtained by the camera 120 to the face identify device 132. According to the image information, the face identify device 132 can determine the number, gender and age of audiences in front of the display unit 110. According to the result of the face identify device 132, the processor 131 can adjust the content of the display unit 110. For example, if there are many female audiences in front of the display unit 110, the control unit 130 will adjust content of the display unit 110 to display advertisements about dresses or jewelries. If there are many male audiences in front of the display unit 110, the control unit 130 will adjust content of the display unit 110 to display advertisement about cars. Furthermore, the face identify device 132 can also determine the ethnicity of audiences, for example, to determine number of audiences with different skin colors such as black, white, and yellow.

The control unit 130 can further include a face tracing device 133. When the face identify device 132 identify a face in the image information of the camera 120, the face tracing device 133 will control the camera 120 to trace the face to determine the action of the audience. For example, the face tracing device 133 can turn the camera 120 to different directions, zoom in the audience or zoom out the audience.

The display device 100 can further include a lighting device 140. When the display device 100 is in a dark environment, the lighting device 140 can illuminate ambient environment of the display device 100 to make the camera 120 to capture relatively clear images.

In the display device 100 described above, the camera 120 is formed on the display device 100 to obtain the image information in front of the display unit 110. According to the image information, the control unit 130 can determine the number, age, gender and ethnicity of the audiences. According to the result, the control unit 130 can adjusts content of the display unit 110. That is, the displayer 100 can adjust the content of the display unit 110 according to different audiences.

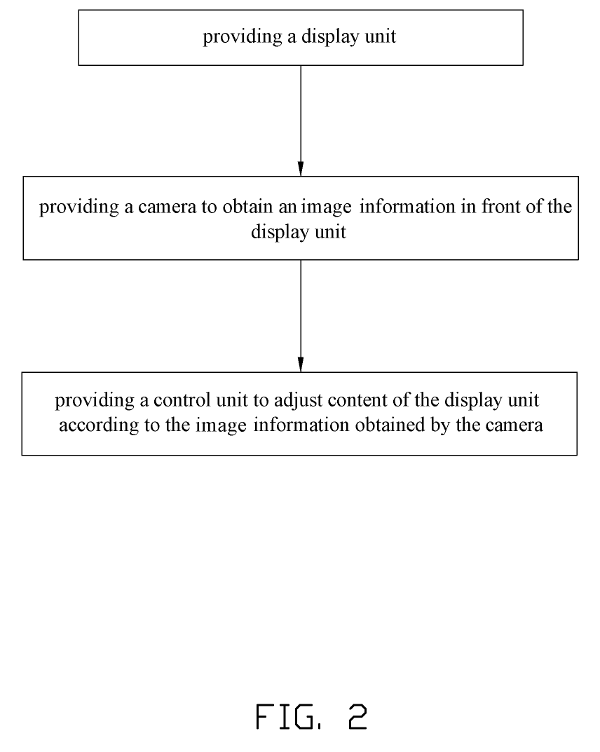

Referring to FIG. 2, a method for adjusting the content of a display device 100 is provided. The method includes the following steps.

A display unit 110 is provided to display video information. The displayer 110 can be liquid crystal display, LED display, plasma display and projecting device. In this embodiment, the content of the display unit 110 is advertisement.

A camera 120 is provided to obtain image information in front of the display unit 110.

A control unit 130 is provided to receive the image information of the camera 120. The control unit 130 adjusts the content of the display unit 110 according to the image information of the camera 120. In this embodiment, the control unit 130 includes a processor 131 and a face identify device 132 connected with the processor 131. The processor 131 transmits the image information of the camera 120 to the face identify device 132. According to the image information of the camera 120, the face identify device 132 can determine the number, age, gender and ethnicity of audiences. According to the result of the face identify device 132, the processor 131 adjusts the content of the display unit 110. Preferably, the control unit 130 can further include a face tracing device 133 to control the camera 120 to trace an audience's face, thereby determining actions of the audience.

A lighting device 140 is further provided. When the display device 100 is in a dark environment, the lighting device 140 can illuminate ambient environment of the display device 100 to make the camera 120 to obtain clear images.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A display device, comprising:
a display unit configured to display video information;
a camera configured to obtain image information in front of the display unit; and
a control unit, receiving the image information obtained by the camera, and adjusting displaying content of the display unit according to the received image information.

2. The display device of claim 1, wherein the content of the display unit is advertisement.

3. The display device of claim 1, wherein the control unit comprises a processor and a face identify device connected with the processor, the processor transmits the image information obtained by the camera to the face identify device, the face identify device determines number, age, gender or ethnicity of audiences according to the image information and transmits the result to the processor, and the processor adjusts the content of the display unit according to the result of the face identify device.

4. The display device of claim 3, wherein the control unit further comprises a face tracing device, when having identified a face of one of the audiences in the image information obtained by the camera, the face tracing device further controls the camera to trace the face to determine an action of the audience.

5. The display device of claim 1, wherein the display unit is selected from a group consist of liquid crystal display, LED display, plasma display and projecting device.

6. The display device of claim 1, further comprising a lighting device to illuminate ambient environment of the display device.

7. A method for adjusting the content of a display unit, comprising:
providing a display unit to display video information;
providing a camera to obtain image information in front of the display unit; and
providing a control unit, the control unit receiving the image information obtained by the camera, and adjusting the content of the display unit according to the received image information.

8. The method of claim 7, wherein the control unit comprises a processor and a face identify device connected with the processor, the processor transmits the image information obtained by the camera to the face identify device, the face identify device determines number, age, gender or ethnicity of audiences according to the image information and transmits the result to the processor, and the processor adjusts the content of the display unit according to the result of the face identify device.

9. The method of claim 8, wherein the control unit further comprises a face tracing device, when having identified a face of one of the audiences in the image information obtained by the camera, the face tracing device further controls the camera to trace the face to determine an action of the audience.

10. The method of claim 7, further comprising a step of providing a lighting device to illuminate ambient environment of the display unit.

11. The method of claim 7, wherein the display unit is selected from a group consisting of liquid crystal display, LED display, plasma display and projecting device.
